(19) United States
(12) Patent Application Publication
(10) Pub. No.: US 2013/0334126 A1
(43) Pub. Date: Dec. 19, 2013

(54) In Line Top Opening Filter Housing Unit

(71) Applicant: Guy J. Van Every, (US)

(72) Inventor: Guy J. Van Every, (US)

(21) Appl. No.: 13/495,960

(22) Filed: Jun. 13, 2012

(51) Int. Cl. B01D 35/34

(52) U.S. Cl. 210/444

(57) ABSTRACT

A filter housing unit having a housing which has inlet and outlet passages, a bottom formed to hold the filters lower end, a filter with a cylindrical center shaft which is accessible through the housings top which is sealed closed with a screw on cap that has a center exit passage which also serves to locate the filters upper end. The caps exit passage flows into a fluid column area allowing filtered fluid to connect with the housing exit passage.

Fluid flows from the inlet through the filter up the center shaft into and out of the cap to the housing exit passage. A filter can be easily replaced by removing the cap making the filter accessible, removing filter and replacing it with a new clean filter and replacing the cap.

### TECHNICAL FIELD

This invention relates to the filtering of fluids, more specifically a top loading replaceable filter system for the ease and safety of replacing filters.

### BACKGROUND OF INVENTION

Many fluid filtering systems are known through prior art and have many positive features but in each there are drawbacks. Some of these include the areas of handling of fluids safely, spilling fluids during filter changes and ease of changing filters, another drawback to existing systems is the manufacturability of components, many have more components adding to complexity and ultimately cost of the filtering system. An example would be U.S. Pat. No. 8,007.669B1 to Larry J. Chernoff the two piece housing which is needed in order to make fluid paths accessible from the underside of the upper region of the housing adding cost to the manufacturing and the location of o-rings could lead to leaks under pressure, a cap screwed directly onto the o-rings would provide a better seal.

It is the objective of this new in line top opening filter housing unit to improve upon or eliminate these drawbacks. The present invention will prove to be easy to clean, easy to change the filter, good to the environment in lack of spillage and less costly to manufacture because of its superior design, and minimum number of components.

### DESCRIPTION OF INVENTION

The present fluid filtering invention consisting of a housing ,the housing being cylindrical with vertically extending side walls a sealed bottom and at the upper end having a larger diameter opening ,a horizontal shelve connects the main side walls to the larger diameter of the top on this horizontal surface a o-ring will be seated. In the upper open end of the housing there is a lip with a groove to seat the second o-ring to provide a leak proof seal ,the outside of the upper end is threaded onto which the cap shall be placed and screwed onto and unscrewed for removal to gain access to the filter for maintenance or changing. The housing also has an inlet and an outlet, the two areas separated by the use of o-rings and the filter itself. The annular walls of the housing provide flow areas between the housing and the filter for the fluid to encompass the filter before going through it.

The sealed bottom of the housing has a cylindrically shaped raised area onto which the filter sits and a raised round pin located in the center of the housings base extending upward to enter the bottom of the filter for locating the filter in its place. A drain port at the bottom side of the housing is internally threaded and will provide a way to drain the housing for cleaning out any sediment that may accumulate. A threaded plug would be used to plug it.

Next would be the filter having a center cylinder, upper and lower end caps with filter media extending outwardly from the central cylinder. The filter having a length as to be sealed between the raised area of the housings bottom and the cylindrically shaped area extending down from the cap, thus separating fluid inlet from fluid outlet.

A cap provided next has a main body diameter from which a cylindrically shaped area extends downward to seat against the filter. An annular extrusion protruding downward from the cap body at its center will enter the upper end of the filter to locate it. A discharge passage starting at the bottom of the extrusion will extend upward to intersect the horizontal passages to let fluid flow unrestricted towards the outlet passage. The main body of the cap has a diameter big enough to cover the o-ring located in the horizontal shelved area of the housing, thus providing a sealed off area of inlet separate from the outlet. The diameter of the caps main body is less than that of the annularly shaped upper end of the housing providing a fluid discharge chamber between the cap body and the housing allowing for free flow of fluid. The top outside portion of the cap has a cylindrically shaped downwardly extending side wall which is threaded on its interior side as to be screwed onto the housing and unscrewed for removal, to assist in this there is a hexagon shaped offset area that can accept a hexagon shaped tool. A flat area between the cap body and the threaded side wall provides an area to seal against the top o-ring thus sealing the fluid in the housing and providing the path to fluid outlet.

Lastly there are two o-rings one to seal incoming fluid from outgoing fluid forcing the fluid through the filter up the exit passage in the cap and the other sealing fluid in the system so there are no leaks into the environment.

It is the intention of the present invention to be much improved over existing systems, being made of a one piece housing with its inlet and outlet passages a closed bottom open top with its outside threaded wall o-ring seating area all in a single easily manufactured component.

The cap low in profile adds to its manufacturability with the discharge passage intersecting the horizontal passages with areas to contact the o-rings and the filter itself to separate the incoming unfiltered fluid form the outgoing filtered fluid.

The advantages of this new filtering unit are to provide an easy way to change a filter located in a housing and be inexpensive to manufacture while being of the highest quality.

### DESCRIPTION OF DRAWINGS

Provided are a series of drawings to assist in the explanation and understanding of this invention.

FIG. 1 Is a top view of an in line top opening filter housing unit.

FIG. 2 Is a front elevation view.

FIG. 3 Is an exploded front elevation view.

FIG. 4 Is a cross section cut in the direction of arrow 4 in the top view.

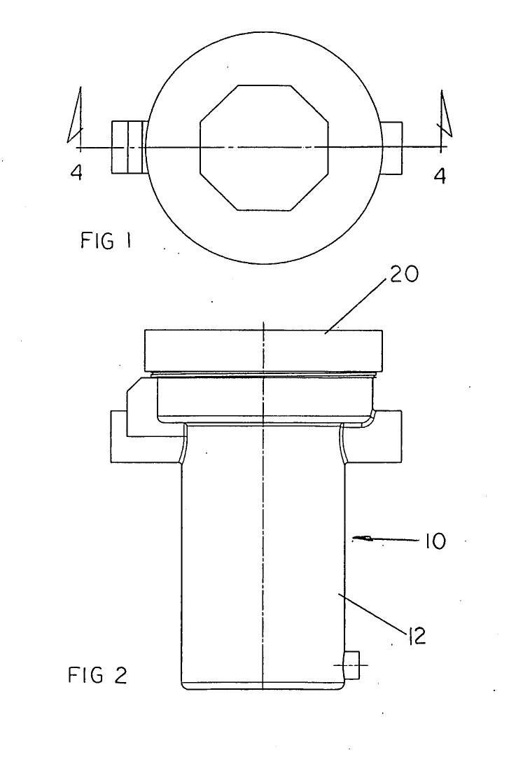

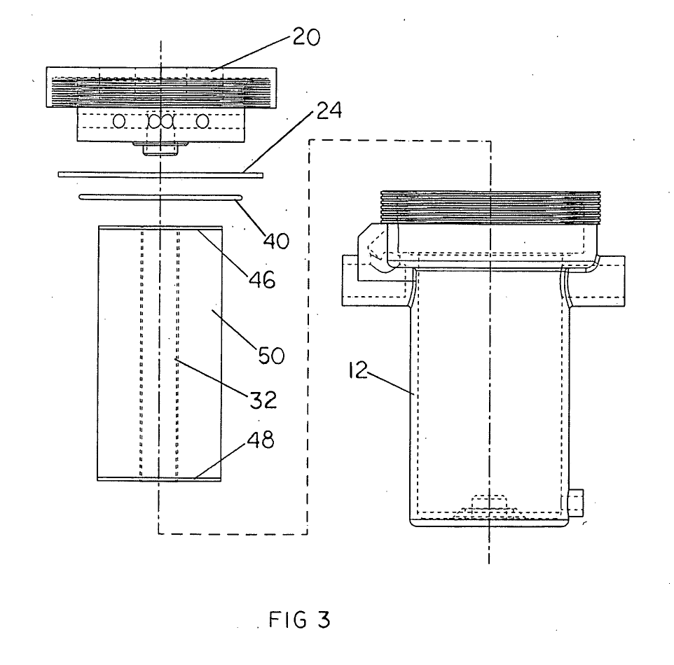

In these drawings components are given numbers, these numbers will be referred to throughout the preceding pages.

### EXPLANATION OF INVENTION COMPONENTS

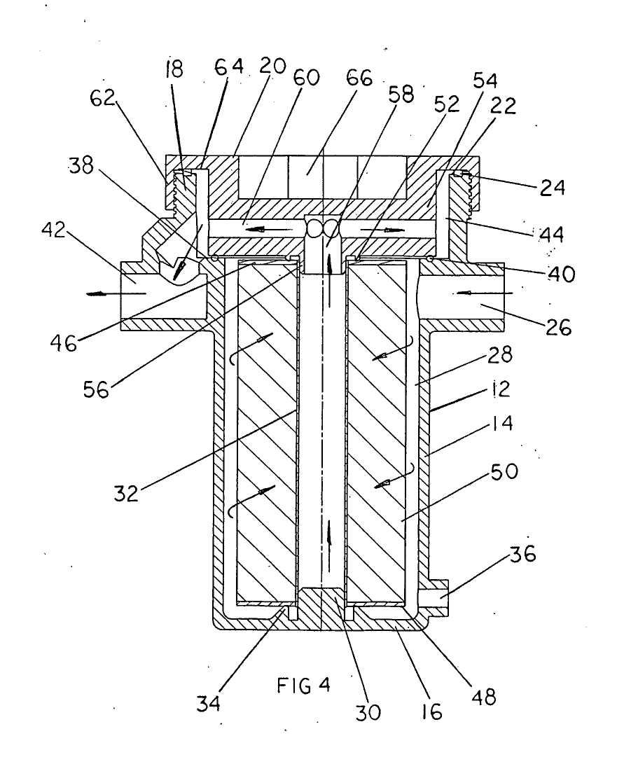

Now referring to the drawings, components and other distinguishing characteristics referred to by their reference numbers seen throughout the drawings most importantly FIG. 4.

The present in line top opening filter housing unit (10) consisting of the housing (12) with its cylindrically shaped vertically extending side walls (14) having a sealed bottom (16) and a larger diameter upper region (18) with threads on its exterior side to accept the cap (20). The housings top rim (22) having a groove to accept an o-ring (24), the housing has an inlet passage (26) which spills into a fluid column area (28) where the fluid encompasses the filter before going thru it. A round pin (30) extending upward into the filters center shaft (32) to locate the filter at its bottom end. Also formed upwardly from the bottom is the annularly shaped filter seat (34), in the side wall at the housings bottom is a threaded drain hole (36) which can accept a threaded plug. The upper region of the housing (18) having a larger diameter than the vertical walls of the main housing body (14), these two cylindrically shaped vertical areas are joined with a flat area (38) where an o-ring (40) is seated. The housing also has an outlet passage (42) extending from fluid column area (44) to the exterior of the housing.

A filter containing a center shaft (32) a top (46) a bottom (48) and filter media (50) extending outwardly from the center shaft (32). The filter has a length so it can be sealed against the housings filter seat (34) and the filter seat (52) found protruding downward from the cap (20).

A cap (20) is located atop the unit, the cap having a main body (54) which has a diameter large enough to cover o-ring (40) seated on flat area (38). The cap has an annularly shaped extrusion (56) extending downward which enters the filters center shaft (32) for locating the filters top end. A filter seat (52) also extending downward from the caps main body has a length to seal the filter at the top and bottom ends when the cap is screwed on. The o-rings make contact with the cap (20) to separate incoming fluid from outgoing fluid also to seal fluid from leaking into the environment. A discharge passage (58) at the center of the cap connects to any number, in this case 6 horizontal passages (60) which allow free flow of fluid to column area (44) which is the space between the caps main body diameter and the vertical walls of the upper end of the housing. The exterior wall of the cap (62) having a diameter which is larger than that of the main cap body (54) leaving a surface (64) to contact the o-ring (24) located in the top rim of the filter housing. On the inside of the caps exterior wall (62) there are threads to be accepted by the housing (12). There is a hexagonally shaped offset in the cap (66) which will accept a tool to assist in the screwing on and off of the cap.

### CONCLUSION, RAMIFICATIONS, SCOPE

With all components assembled being the new invention known as the in line top opening filter housing unit the reader will see that, a one piece easily manufactured housing with a screw on cap and filter or any other type of media that one might want to flow a fluid thru, can be accomplished with this unit.

Knowing modifications can be made sizes changed descriptions altered the patent of the presented invention should not be limited to the pages here unto describing nor art showing, but cover a broader spectrum of the idea and design of the presented invention.

It is claimed and should be protected by patent law that:

1. A top opening filter housing unit comprising:
a one piece filter housing having cylindrical side walls with inlet and outlet passages a closed bottom with an area for a filter to sit, a larger cylindrical upper region and a horizontal shelf at a distance from the top where an o-ring is seated, the upper region having a depth to accept the cap and compress the o-rings to seal incoming and outgoing areas, the top rim of the housing which has a groove for an o-ring to seat and threads on the outside;
a filter with a center cylinder, a top plate a bottom plate and filter media extending from the center cylinder outward the filter having a length to seal against the raised area at the bottom of the housing and the cap;
a cap with a main body having a diameter as to cover the o-ring seated on the shelf area of the housing, at the center of the cap is an annular shaped extrusion protruding downward that enters the filters top to locate it, up the center of this extrusion is a discharge passage intersecting horizontal passages for fluid flow to the housings outlet passage, the threaded inside of the caps outer wall is at a dimension from the main body diameter leaving an area to contact the o-ring to contain fluid in the housing;
two o-rings previously mentioned one located on the horizontal shelf beneath the main body diameter of the cap to separate incoming unfiltered fluid from outgoing filtered fluid, the other o-ring located on the top rim of the housing just inside the threaded exterior wall to seal fluids inside the unit.
